(19) United States
(12) Patent Application Publication
(10) Pub. No.: US 2019/0126724 A1
(43) Pub. Date: May 2, 2019

(54) Under Vehicle Mounted Cooling Assemblies Including Horizontally Mounted Condensers With Vertical Air Flow

(71) Applicants: DENSO International America, Inc., Southfield, MI (US); DENSO CORPORATION, Kariya-city (JP)

(72) Inventors: Nicholaus SPUNAR, Southfield, MI (US); Yasuhiro SEKITO, Novi, MI (US); Christopher WISNIEWSKI, Ann Arbor, MI (US); Shinichiro HIRAI, Farmington Hills, MI (US)

(21) Appl. No.: 16/142,100

(22) Filed: Sep. 26, 2018

Related U.S. Application Data
(60) Provisional application No. 62/577,364, filed on Oct. 26, 2017.

(51) Int. Cl. B60H 1/32; B60H 1/00

(52) U.S. Cl. CPC B60H 1/3227; B60H 1/00328; B60H 1/3229; B60H 2001/3291; B60H 2001/3272; B60H 2001/3277; B60H 2001/003

(57) ABSTRACT

A cooling assembly for under a vehicle is provided. The cooling assembly includes a housing, a slab condenser, and a condenser fan. The housing is configured to be attached under and to a floor of the vehicle. The housing includes a top wall, side walls and a bottom wall. The slab condenser is disposed within the housing and horizontally oriented when the housing is attached to the vehicle. The condenser fan assembly is disposed within the housing and directing air vertically through the top wall, the bottom wall and the slab condenser.

### CROSS-REFERENCE TO RELATED APPLICATIONS

This application claims the benefit of U.S. Provisional Application No. 62/577,364, filed on Oct. 26, 2017. The entire disclosure of the above application is incorporated herein by reference.

### FIELD

The present disclosure relates to vehicle cooling systems.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Traditional vehicles include internal combustion engines (ICEs) for propulsion purposes and air-conditioning systems for controlling temperatures within interiors of the vehicles. An air-conditioning system may include a condenser, a compressor, an expansion valve and an evaporator. The condenser is a vertically mounted and located along with the compressor under a front hood of a vehicle. The condenser is often located forward of a radiator of the vehicle. A forward facing vertically oriented side of the condenser receives air directed through a front fascia of the vehicle. The air is forced through the condenser while the vehicle is moving in a forward direction. A fan may be located rearward of the condenser and draw air through the condenser. The air passing through the condenser cools a refrigerant in the condenser. The fan may be an electrically actuated fan.

### SUMMARY

A cooling assembly for under a vehicle is provided. The cooling assembly includes a housing, a slab condenser, and a condenser fan. The housing is configured to be attached under and to a floor of the vehicle. The housing includes a top wall, side walls and a bottom wall. The slab condenser is disposed within the housing and horizontally oriented when the housing is attached to the vehicle. The condenser fan assembly is disposed within the housing and directing air vertically through the top wall, the bottom wall and the slab condenser.

In other features, a cooling assembly for under a vehicle is provided. The cooling assembly includes a housing, a slab condenser and a condenser fan assembly. The housing is configured to be attached under and to an underbody structure of the vehicle. The housing comprises a top wall, side walls and a bottom wall. The slab condenser is disposed within the housing and oriented at less than a 45° angle relative to a horizontally oriented portion of the underbody structure when the housing is attached to the vehicle. The condenser fan assembly is disposed within the housing and directing air through the top wall, the bottom wall and the slab condenser.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including a under vehicle mounted cooling assembly in accordance with an embodiment of the present disclosure;

FIG. 2 is a cross-sectional side view of an example of the under vehicle mounted cooling assembly of FIG. 1, which is mounted to a floor of the vehicle and includes a bottom mounted condenser in accordance with an embodiment of the present disclosure;

FIG. 3 is a top view of a refrigeration system including an under vehicle mounted cooling assembly in accordance with an embodiment of the present disclosure; and

FIG. 4 is a cross-sectional side view of another example of the under vehicle mounted cooling assembly of FIG. 1, which is mounted to a floor of the vehicle and includes a top mounted condenser in accordance with an embodiment of the present disclosure.

In the drawings, reference numbers may be reused to identify similar and/or identical elements.

### DETAILED DESCRIPTION

Vehicles are constantly evolving to have: different types and combinations of propulsion systems; different interior cabin configurations; and an increased number of electrical and electronic components. As an example, an autonomous vehicle may include electric motors, multiple processors, and other electrical and/or electronic components. Life of the electrical/electronic components may degrade over time if not maintained below predetermined temperatures and/or within predetermined operating temperature ranges. Degradation of the electrical/electronic components can result in operation errors, degraded operating performance, slower processing speeds, etc. As a result, additional cooling may be needed over traditional techniques to maintain the electrical/electronic components within corresponding predetermined operating temperature ranges.

Also, different types of vehicle require different amounts of cooling. For example, larger vehicles, such as limousines, buses, motorhomes, etc. require more cooling capacity, than small vehicles, such as sedans, coupes, light or medium size trucks, etc. Vehicles configured to include larger numbers of passengers (e.g., more than 8 passengers) typically require larger amounts of cooling capacity than vehicle with small numbers of passengers (e.g., 8 or less passengers).

Condensers that are mounted under a hood of a vehicle typically have corresponding space constraints, which limit the sizes and location of the condensers. For example, a vertically oriented condenser is limited in size by vehicle components located around the condenser, such as a vehicle frame, hood, quarter panels, fascia components, hoses, wires, etc. By limiting the size of the condenser, the cooling capacity of the condenser is limited.

The examples set forth herein include under vehicle mounted cooling assemblies (UVMCAs) operable to provide cooling for various vehicle components and devices (e.g., electrical components, electronic devices, evaporator, chiller, heat exchanger, etc.). The UVMCAs may be used alone, in combination with, and/or to supplement other cooling assemblies, refrigeration systems, and/or air-conditioning systems. The UVMCAs include horizontally disposed condensers having corresponding vertical air flow therethrough. The horizontal arrangement of the condensers allow for the vehicle mounted cooling assemblies to be located in spaces of a vehicle where there is limited vertical space available. The horizontal arrangement of the condensers also allows the condensers to have increased size and/or cross-sectional area for increased cooling capacity. As an example, a vehicle mounted cooling assembly may be disposed under a floor of a vehicle, where the corresponding condenser extends parallel to the floor of the vehicle. There are fewer adjacent vehicle components under a vehicle that would interfere with placement of a horizontally oriented condenser, than would interfere with a vertically oriented condenser under a hood and in, for example, an engine bay area of a vehicle. The UVMCAs are configured to maximize heat rejection and thus maximize cooling capacity while having a minimal corresponding packaging envelope.

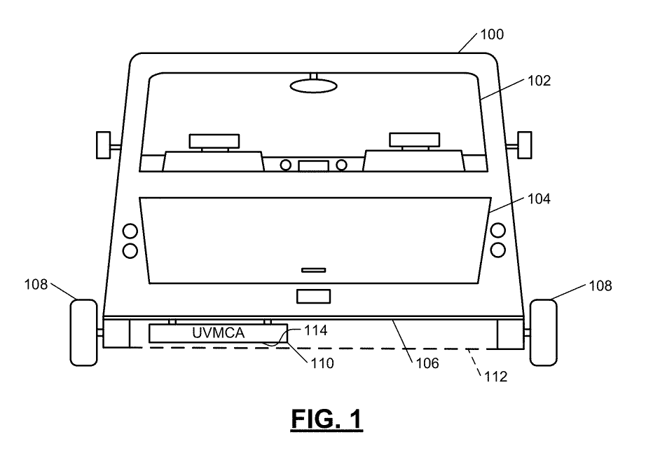

FIG. 1 shows a vehicle 100 that includes a cabin 102, a trunk 104, a floor 106, rear wheels 108 and a UVMCA 110. The floor 106 may be a bottom portion of the trunk 104, a bottom portion of the cabin 102, or other bottom portion of the vehicle 100. The UVMCA 110 may be mounted to and below the floor 106. In an embodiment, the UVMCA 110 is mounted below the vehicle 100 and hangs from the floor 106. The UVMCA 110 may be located in a rear portion of the vehicle 100, for example, between or aft of the rear wheels 108. The UVMCA 110 may be visible when looking under the vehicle 100, as shown.

In an embodiment, the UVMCA 110 is hidden from sight when looking from in front, a side and/or behind the vehicle due to shields 112 and/or other vehicle components located around a perimeter of the UVMCA 110. The shields 112 may be connected to the floor 106 and/or to other components of the vehicle 100. In one embodiment, one or more of the shields 112 are connected to the UVMCA 110. The shields 112 may be plates use to protect the UVMCA 110 and/or other vehicle components. In one embodiment, at least portions of the shields 112 extend vertically and do not cover the bottom 114 of the UVMCA 110. In another embodiment, at least a portion of one of the shields 112 includes perforations (or holes), extends horizontally and covers the bottom 114 of the UVMCA 110.

The UVMCA 110 may be included in a refrigeration system, a cooling system, and/or an air-conditioning system. The UVMCA 110 may include as further described below, a horizontally oriented condenser, a condenser fan, a compressor, and a dryer receiver. The UVMCA 110 may include the only condenser, condenser fan, compressor and/or dryer receiver of the vehicle 100 or may include an additional condenser, condenser fan, compressor and/or dryer receiver of the vehicle 100. Thus, the vehicle 100 may include one or more condensers, one or more condenser fan assemblies, one or more compressors, and/or one or more dryer receivers. The condenser, condenser fan assembly, compressor and/or dryer receiver of the UVMCA 110 may be shared by two or more refrigeration systems. The UVMCA 110 may be included on the vehicle 100 to cool a refrigerant used to cool electrical components, electronic devices, drivetrain components, other components and devices, an interior of a cooling box (or refrigerator), and/or air within the cabin 102.

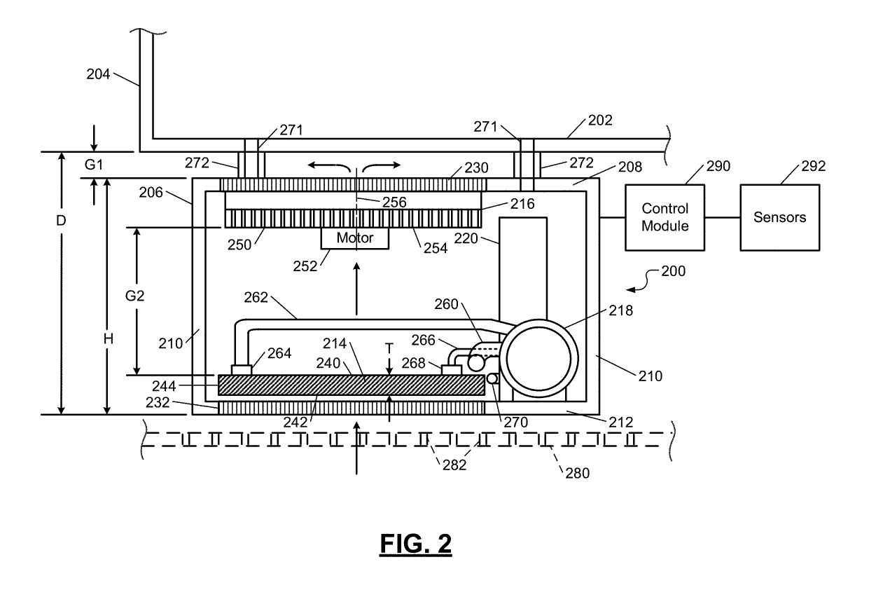

FIG. 2 shows an example of the UVMCA of FIG. 1. A UVMCA 200 is shown that is mounted to a floor 202 of a vehicle 204. Although the UVMCA 200 is shown as being mounted to the floor 202 of the vehicle 204, the UVMCA 200 may be mounted to other underbody structures of the vehicle 204, such as a frame, a panel, a floor board, etc. The UVMCA 200 includes a housing 206 having a top wall 208, side walls 210, and a bottom wall 212. The UVMCA 200 further includes, within the housing 206, a condenser 214, a condenser fan assembly 216, a compressor 218, and a dryer receiver 220.

The walls 208, 210, 212 may be formed of, for example, steel, aluminum, plastic, and/or other suitable materials. The top wall 208 and the bottom wall 212 of the housing 206 may include perforations and/or a protective screen. As an example, two protective screens 230, 232 are shown as being incorporated in the walls 208, 212. The walls 208, 212 and the protective screens 230, 232 may be used to protect the condenser 214 and the condenser fan assembly 216 while allowing air to flow vertically through the housing 206, the walls 208, 212, and/or the protective screens 230, 232. The air may flow through the bottom wall 212 first and then through the condenser 214, the condenser fan assembly 216 and the top wall 208. This is referred to as a “draw through” configuration. In another embodiment, the condenser fan assembly 216 directs the air first through the top wall 208, then through the condenser fan assembly 216, the condenser 214 and the bottom wall 212. This is referred to as a “blow through” configuration.

The protective screens 230, 232 may have a lattice type or honeycomb type structure and prevent rocks and/or other debris from hitting and/or entering the condenser 214 and/or the condenser fan assembly 216. The protective screens 230, 232 may be fastened to the walls 208, 212 or formed as an integral part of the walls 408, 412. In one embodiment, the protective screens 230, 232 are not included and the walls 208, 212 include perforations to allow air to flow through the walls 208 and 212. In another embodiment, portions of the walls 208, 212 are absent, such that air is free to flow directly into and out of the housing 206, the condenser 214, and the condenser fan assembly 216.

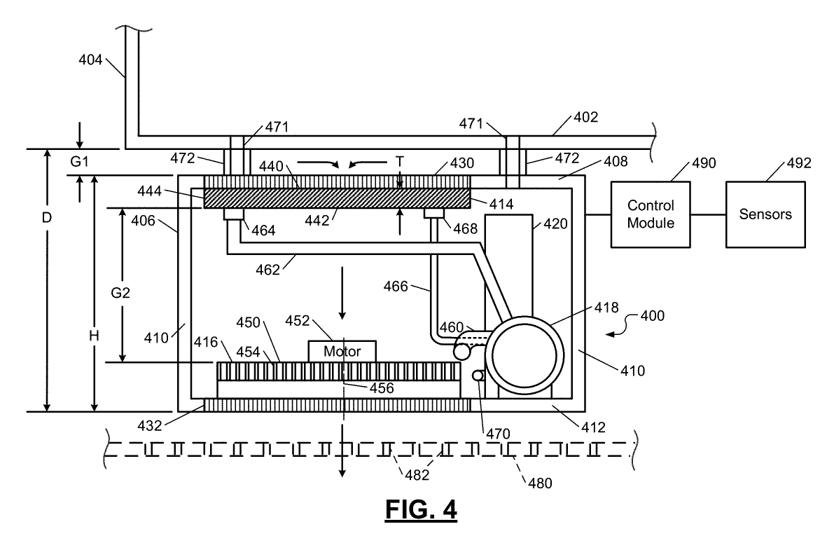

The condenser 214 is referred to as a “slab” style condenser. The condenser 214 has a top peripheral surface 240, a bottom peripheral surface 242, and peripheral side surfaces 244. A thickness T of the condenser 214 between the top peripheral surface 240 and the bottom peripheral surface 242 is less than a predetermined thickness to minimize height H of the housing 206. A lateral cross-sectional area of the condenser 214 may be of various sizes and may be as large as or larger than traditional vertically oriented condensers. Although the condenser 214 is shown as being below the condenser fan assembly 216, the condenser 214 may be located above the condenser fan assembly 216, as shown in FIG. 4.

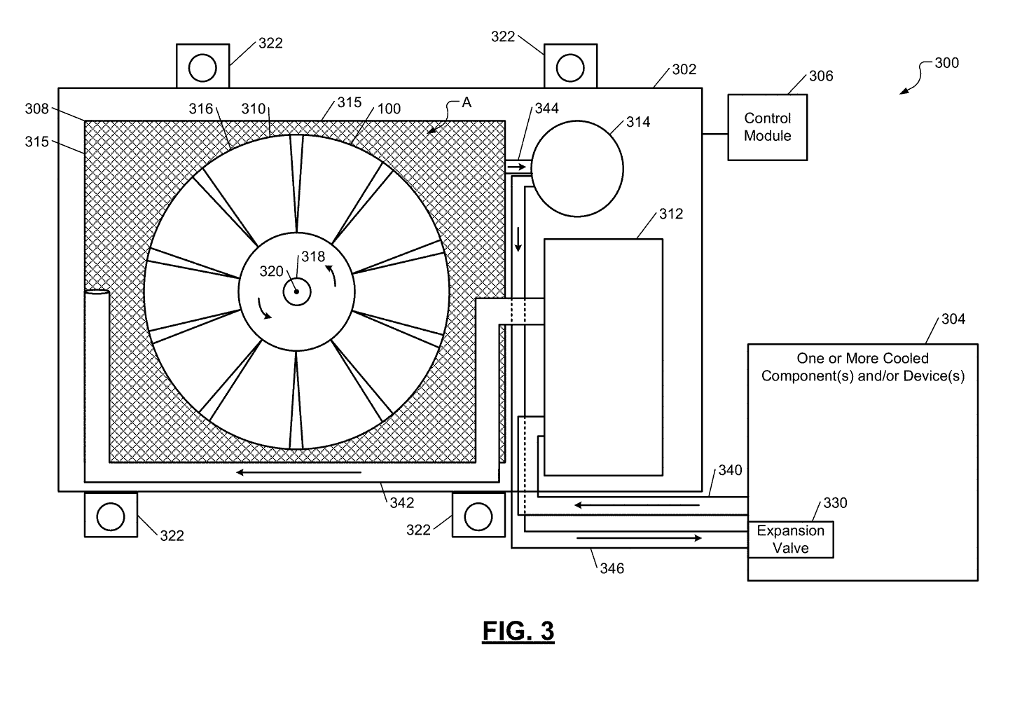

The condenser fan assembly 216 may include a fan housing 250, an electric motor 252 and a fan (an example of which is shown in FIG. 3). As shown, a bottom portion of the fan housing 250 includes louvers (or angled slats) 254 to allow passage of air and mounting of the motor 252. A top portion of the condenser fan assembly 216 may be open as shown in FIG. 3. The air flows in a direction parallel to an axis of rotation 256 of the fan. The air may flow through the condenser fan assembly 216 and out and over the top wall 208 as shown.

The compressor 218 and the dryer receiver 220 are mounted on the bottom wall 212 adjacent to the condenser 214 and within the housing 206. The compressor 218 and the dryer receiver 220 may not be disposed between the condenser 214 and the condenser fan assembly 216 and/or in a path of air flow through the housing 206 to minimize restriction of air flow through the condenser 214. During operation, refrigerant flows into an inlet (or first) line 260 to the compressor 218, is compressed by the compressor 218 and then flows out of the compressor 218 via a second line 262 to the condenser 214. The refrigerant is condensed and cooled in the condenser 214. The second line 262 is connected to the condenser 214 via a first connector 264. The refrigerant flows through the condenser 214 and to the dryer receiver 220 via a third line 266. The dryer receiver 220 removes water vapor from the refrigerant. The third line 266 is connected to the condenser 214 via a second connector 268. The refrigerant flows from the dryer receiver 220 out an outlet (or fourth) line 270.

Although the condenser 214 and the condenser fan assembly 216 are shown as being in horizontal orientations, the condenser 214 and the condenser fan assembly 216 may be oriented at angles less than, for example, 45° relative to a first horizontal plane and/or a horizontally extending portion of the floor 202 or other underbody structure. The first horizontal plane may extend laterally through a portion of the floor 202 or across a bottom most surface of the floor 202. A second horizontal plane extending across a top surface of the top side 240 or a bottom surface of the bottom side 242 may be at an angle less than 45° relative to the first horizontal plane and/or a horizontally extending portion of the floor 202 or other underbody structure. Also, although the condenser 214 and the condenser fan assembly 216 are shown as extend parallel to each other, parallel to the walls 208, 212, and perpendicular to the walls 210, the condenser 214 and the condenser fan assembly 216 may not extend parallel to each other, parallel to the walls 208, 212, and/or perpendicular to the walls 210. Although the fan housing 250 is shown as being mounted flush against the top wall 208 and the condenser 214 is shown as being spaced away from the bottom wall 212, the fan housing 250 may be spaced away from the top wall 208 and the condenser 214 may be mounted flush against the bottom wall 212.

In an embodiment, a first gap G1 between the housing 206 and the floor 202 and a second gap G2 between the condenser fan assembly 216 and the condenser 214 are set to minimize the height H and a distance D between the floor 202 and a bottom of the bottom wall 212. The gaps G1 and G2 may be set to maximize air flow through the housing 206 and thus through the condenser 214 and to minimize load on the motor 252.

The housing 206 may be hung from the floor 202 via hanging fasteners 271. In the example shown, the hanging fasteners 271 extend through shock absorbing members 272 and connect to the floor 202 and the top wall 208. In an embodiment, the hanging fasteners 271 have threaded ends and screw into the floor 202, the top wall 208, and/or brackets attached to the floor 202 and/or the top wall 208. The shock absorbing members 272 may be formed of, for example, rubber, plastic and/or other suitable materials. In an embodiment, the shock absorbing members 272 are rubber isolation grommets. The shock absorbing members 272 may be disposed between the floor 202 and the top wall 208, as shown, between the hanging fasteners 271 and the floor 202, and/or between the hanging fasteners 271 and the top wall 208.

In one embodiment, a protective shield 280 is disposed below the UVMCA 200 and housing 206 and includes perforations 282. The protective shield 280 may be attached to the floor 202 and/or other components of the vehicle 204. The protective shield 280 is an example of one of the horizontally extending protective shields 112 of FIG. 1. In another embodiment, the protective shield 280 is not included.

A control module 290 may be electrically connected to the compressor 218 and the motor 252. The control module 290 may activate and control speeds of the compressor 218 and the motor 252 based on signals from sensors 292. The sensors 292 may include temperatures sensors, humidity sensors, and/or other vehicle sensors. The sensors 292 may be located anywhere within and/or external to the vehicle 204. The sensors 292 may also monitor temperatures within the housing 206 including, for example, a temperature of the compressor 218.

FIG. 3 shows a refrigeration system 300 that includes a UVMCA 302, one or more cooled components and/or devices 304, and a control module 306. The UVMCA 302 may be configured similarly or the same as any of the UVMCAs disclosed herein. The UVMCA 302 includes a condenser 308, a condenser fan assembly 310, a compressor 312 and a dryer receiver 314. The condenser 308 has top and bottom peripheral surfaces (e.g., peripheral surfaces 240, 242 of FIG. 2) with a large surface area A defined by lengths of sides 315 and structure of the condenser 308. The top and bottom peripheral surfaces may extend perpendicular to a direction of air flow through the condenser fan assembly 310.

The condenser fan assembly 310 includes a fan 316 that has a shaft 318 via which the fan 316 is rotated about an axis of rotation 320. The shaft 318 is rotated via a motor (e.g., the motor 252 of FIG. 2). The UVMCA 302 may be connected to and hung from a floor (e.g., the floor 202 of FIG. 2) of a vehicle via hangers 322. The hangers 322 may be brackets attached to a housing and/or side walls of the UVMCA 302 and to the floor.

The one or more cooled components or devices 304 may include one or more evaporators, chillers, heat exchangers, drivetrain components, electrical and/or electronic components and devices, etc. The one or more cooled components or devices 304 may be cooled by the refrigerant circulated through the condenser 308 and the dryer receiver 314 and provided to the one or more cooled components or devices 304. The evaporators may be used to cool air within a cabin of a vehicle. The chillers may be used to cool electrical and/or electronic components and devices. The refrigerant may be circulated through some of the one or more cooled components or devices 304 and may not be circulated through other ones of the one or more cooled components or devices 304. The one or more cooled components or devices 304 may include an expansion valve 330. The expansion valve 330 may receive the refrigerant from the dryer receiver 314 prior to being provided to other components and/or devices.

Refrigerant flows from the one or more cooled components or devices 304 via a first line 340 to the compressor 312. The refrigerant then flow from the compressor 312 to the condenser 308 via a second line 342. The refrigerant is supplied from the condenser 308 to the dryer receiver 314 via a third line 344 and then from the dryer receiver 314 to the one or more cooled components or devices 304 via a fourth line 346.

FIG. 4 shows another example of the UVMCA 110 of FIG. 1. A UVMCA 400 is shown that is mounted to a floor 402 of the vehicle 404. Although the UVMCA 200 is shown as being mounted to the floor 402 of the vehicle 404, the UVMCA 400 may be mounted to other underbody structures of the vehicle 404, such as a frame, a panel, a floor board, etc. The UVMCA 400 includes a housing 406 having a top wall 408, side walls 410, and a bottom wall 412. The UVMCA 400 further includes, within the housing 406, a condenser 414, a condenser fan assembly 416, a compressor 418, and a dryer receiver 420. The UVMCA 400 is configured similarly as the UVMCA 200 of FIG. 2, except that the condenser 414 is disposed above the condenser fan assembly 416.

The walls 408, 410, 412 may be formed of, for example, steel, aluminum, plastic, and/or other suitable materials. The top wall 408 and the bottom wall 412 of the housing 406 may include perforations and/or a protective screen. As an example, two protective screens 430, 432 are shown as being incorporated in the walls 408, 412. The walls 408, 412 and the protective screens 430, 432 may be used to protect the condenser 414 and the condenser fan assembly 416 while allowing air to flow vertically through the housing 406, the walls 408, 412, and/or the protective screens 430, 432. For a draw through configuration, the air may flow through the top wall 408 first and then through the condenser fan assembly 416, the condenser 414 and the bottom wall 412. In another embodiment and for a blow through configuration, the condenser fan assembly 416 directs the air first through the bottom wall 412, then through the condenser fan assembly 416, the condenser 414 and the top wall 408.

The protective screens 430, 432 may have a lattice type or honeycomb type structure and prevent rocks and/or other debris from hitting and/or entering the condenser 414 and/or the condenser fan assembly 416. The protective screens 430, 432 may be fastened to the walls 408, 412 or formed as an integral part of the walls 408, 412. In one embodiment, the protective screens 430, 432 are not included and the walls 408, 412 include perforations to allow air to flow through the walls 408 and 412. In another embodiment, portions of the walls 408, 412 are absent, such that air is free to flow directly into and out of the housing 406, the condenser 414 and the condenser fan assembly 416.

The condenser 414 is referred to as a “slab” style condenser. The condenser 414 has a top peripheral surface 440, a bottom peripheral surface 442, and peripheral side surfaces 444. A thickness T of the condenser 414 between the top peripheral surface 440 and the bottom peripheral surface 442 is less than a predetermined thickness to minimize height H of the housing 406. A lateral cross-sectional area of the condenser 414 may be of various sizes and may be as large as or larger than traditional vertically oriented condensers. Although the condenser 414 is shown as being below the condenser fan assembly 416, the condenser 414 may be located above the condenser fan assembly 416, as shown in FIG. 4.

The condenser fan assembly 416 may include a fan housing 450, an electric motor 452 and a fan (an example of which is shown in FIG. 3). As shown, a top portion of the fan housing 450 includes louvers (or angled slats) 454 to allow passage of air and mounting of the motor 452. A bottom portion of the condenser fan assembly 416 may be open. The air flows in a direction parallel to an axis of rotation 456 of the fan. The air may flow through the condenser fan assembly 416 and out the bottom wall 412 as shown.

The compressor 418 and the dryer receiver 420 are mounted on the bottom wall 412 adjacent to the condenser 414. The compressor 418 and the dryer receiver 420 may not be disposed between the condenser 414 and the condenser fan assembly 416 and/or in a path of air flow through the housing 406 to minimize restriction of air flow through the condenser 414. During operation, refrigerant flows into an inlet (or first) line 460 to the compressor 418, is compressed by the compressor 418 and then flows out of the compressor 418 via a second line 462 to the condenser 414. The refrigerant is condensed and cooled in the condenser 414. The second line 462 is connected to the condenser 414 via a first connector 464. The refrigerant flows through the condenser 414 and to the dryer receiver 420 via a third line 466. The dryer receiver 420 removes water vapor from the refrigerant. The third line 466 is connected to the condenser 414 via a second connector 468. The refrigerant flows from the dryer receiver 420 out an outlet (or fourth) line 470.

Although the condenser 414 and the condenser fan assembly 416 are shown as being in horizontal orientations, the condenser 414 and the condenser fan assembly 416 may be oriented at angles less than, for example, 45° a first horizontal plane and/or a horizontally extending portion of the floor 402 or other underbody structure. The first horizontal plane may extend laterally through a portion of the floor 402 or across a bottom most surface of the floor 402. A second horizontal plane extending across a top surface of the top side 440 or a bottom surface of the bottom side 442 may be at an angle less than 45° relative to the first horizontal plane and/or a horizontally extending portion of the floor 402 or other underbody structure. Also, although the condenser 414 and the condenser fan assembly 416 are shown as extending parallel to each other, parallel to the walls 408, 412, and perpendicular to the walls 410, the condenser 414 and the condenser fan assembly 416 may not extend parallel to each other, parallel to the walls 408, 412, and/or perpendicular to the walls 410. Although the fan housing 450 is shown as being mounted flush against the bottom wall 412 and the condenser 414 is shown as being mounted flush against the top wall 408, the fan housing 450 may be spaced away from the bottom wall 412 and the condenser 414 may be spaced away from the top wall 408.

In an embodiment, a first gap G1 between the housing 406 and the floor 402 and a second gap G2 between the condenser fan assembly 416 and the condenser 414 are set to minimize the height H and a distance D between the floor 402 and a bottom of the bottom wall 412. The gaps G1 and G2 may be set to maximize air flow through the housing 406 and thus through the condenser 414 and to minimize load on the motor 452.

The housing 406 may be hung from the floor 402 via hanging fasteners 471. In the example shown, the hanging fasteners 471 extend through shock absorbing members 472 and connect to the floor 402 and the top wall 408. In an embodiment, the hanging fasteners 471 have threaded ends and screw into the floor 402, the top wall 408, and/or brackets attached to the floor 402 and/or the top wall 408. The shock absorbing members 472 may be formed of, for example, rubber, plastic and/or other suitable materials. In an embodiment, the shock absorbing members 472 are rubber isolation grommets. The shock absorbing members 472 may be disposed between the floor 402 and the top wall 408, as shown, between the hanging fasteners 471 and the floor 402, and/or between the hanging fasteners 471 and the top wall 408.

In one embodiment, a protective shield 480 is disposed below the UVMCA 200 and housing 406 and includes perforations 482. The protective shield 480 may be attached to the floor 402 and/or other components of the vehicle 404. The protective shield 480 is an example of one of the horizontally extending protective shields 112 of FIG. 1. In another embodiment, the protective shield 480 is not included.

A control module 490 may be electrically connected to the compressor 418 and the motor 452. The control module 490 may activate and control speeds of the compressor 418 and the motor 452 based on signals from sensors 492. The sensors 492 may include temperatures sensors, humidity sensors, and/or other vehicle sensors. The sensors 492 may be located anywhere within and/or external to the vehicle 404. The sensors 492 may also monitor temperatures within the housing 406 including, for example, a temperature of the compressor 418.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A cooling assembly for under a vehicle, the cooling assembly comprising:
a housing configured to be attached under and to a floor of the vehicle, wherein the housing comprises a top wall, side walls and a bottom wall;
a slab condenser disposed within the housing and horizontally oriented when the housing is attached to the vehicle; and
a condenser fan assembly disposed within the housing and directing air vertically through the top wall, the bottom wall and the slab condenser.

2. The cooling assembly of claim 1, wherein the condenser fan assembly draws air through the slab condenser.

3. The cooling assembly of claim 1, wherein the condenser fan assembly directs air through the slab condenser.

4. The cooling assembly of claim 1, wherein the condenser fan assembly is disposed above the condenser.

5. The cooling assembly of claim 1, wherein the condenser fan assembly is disposed below the condenser.

6. The cooling assembly of claim 1, further comprising:
a compressor configured to receive and compress a refrigerant prior to the refrigerant being provided to the slab condenser; and
a dryer receiver configured to receive the refrigerant from the slab condenser and dry the refrigerant prior to being directed out of the housing.

7. The cooling assembly of claim 1, wherein further comprising a plurality of hangers configured to hang the housing from the floor of the vehicle.

8. The cooling assembly of claim 7, wherein:
a gap exists between the housing and the floor when the housing is attached via the plurality of hangers to the floor; and
the plurality of hangers are configured, such that the gap is sized to (i) minimize restricting air flow through at least one of the housing, the slab condenser or the condenser fan assembly, and (ii) minimize a distance between the floor and a bottom of the housing.

9. The cooling assembly of claim 1, wherein:
a gap exists between the slab condenser and the condenser fan assembly; and
the slab condenser is disposed relative to the condenser fan assembly, such that the gap is sized to (i) minimize restricting air flow through at least one of the housing, the slab condenser or the condenser fan assembly, and (ii) minimize a distance between the floor and a bottom of the housing.

10. A refrigeration system comprising:
the cooling assembly of claim 1, wherein the condenser fan assembly comprises
a fan, and
a motor configured to rotate the fan;
at least one sensor configured to generate at least one signal; and
a control module configured to control a speed of the fan based on the at least one signal.

11. The refrigeration system of claim 10, wherein:
the cooling assembly further comprises a compressor;
the compressor is disposed within the housing; and
the control module controls a speed of the condenser based on the at least one signal.

12. A cooling assembly for under a vehicle, the cooling assembly comprising:
a housing configured to be attached under and to an underbody structure of the vehicle, wherein the housing comprises a top wall, side walls and a bottom wall;
a slab condenser disposed within the housing and oriented at less than a 45° angle relative to a horizontally oriented portion of the underbody structure when the housing is attached to the vehicle; and
a condenser fan assembly disposed within the housing and directing air through the top wall, the bottom wall and the slab condenser.

13. The cooling assembly of claim 12, wherein the slab condenser is mounted at least one of horizontally within the housing or parallel to the horizontally oriented portion of the underbody structure when the housing is attached to the underbody structure.

14. The cooling assembly of claim 12, wherein:
the underbody structure is a floor, a frame, a panel, or a floor board; and
the housing is attached indirectly to the underbody structure.

15. The cooling assembly of claim 12, wherein at least one of the top wall and the bottom wall of the housing are oriented at less than a 45° angle relative to the horizontally oriented portion of the underbody structure when the housing is attached to the underbody structure.

16. The cooling assembly of claim 12, wherein at least one of the top wall and the bottom wall of the housing are horizontally oriented when the housing is attached to the underbody structure.

17. The cooling assembly of claim 12, further comprising:
a compressor configured to receive and compress a refrigerant prior to the refrigerant being provided to the slab condenser; and
a dryer receiver configured to receive the refrigerant from the slab condenser and dry the refrigerant prior to being directed out of the housing.

18. The cooling assembly of claim 12, wherein the condenser fan assembly draws air through the slab condenser and is disposed above the slab condenser.

19. The cooling assembly of claim 12, wherein the condenser fan assembly draws air through the slab condenser and is disposed below the slab condenser.

20. A refrigeration system comprising:
the cooling assembly of claim 12, wherein the condenser fan assembly comprises
a fan, and
a motor configured to rotate the fan;
at least one sensor configured to generate at least one signal;
a compressor disposed within the housing; and
a control module configured to, based on the at least one signal, control (i) a speed of the fan, and (ii) a speed of the condenser.
